(19) United States
(12) Patent Application Publication
(10) Pub. No.: US 2022/0325968 A1
(43) Pub. Date: Oct. 13, 2022

(54) ELECTRICAL CONNECTOR FOR A FIREARM

(71) Applicant: T-Worx Holdings, LLC, Sterling, VA (US)

(72) Inventors: Eric F. Cabahug, Fairfax, VA (US); Benjamin F. Feldman, Reston, VA (US); Tyler J. Miller, Dickerson, MD (US); Tho N. Nguyen, Ashburn, VA (US)

(73) Assignee: T-Worx Holdings, LLC, Sterling, VA (US)

(21) Appl. No.: 17/228,394

(22) Filed: Apr. 12, 2021

(51) Int. Cl. F41A 3/66; H01R 13/639; H01R 13/70

(52) U.S. Cl. CPC F41A 3/66; H01R 13/639; H01R 13/701; F41G 11/00

(57) ABSTRACT

A firearm includes a lower receiver that houses a power source, and an upper receiver is attached to the lower receiver. The upper receiver has at least one conductive strip that provides an electrical connection for a firearm accessory. A connector having a plug portion terminates electrical wiring connected to the power source in the lower receiver. A power switch assembly has a receptacle portion that receives the plug portion of the connector, and a fastener assembly for mounting the power switch assembly to a slot on the upper receiver. The slot provides a firearm accessory mounting location. The power switch assembly is operable to connect and disconnect a transfer of electrical power from the connector to the at least one conductive strip.

### BACKGROUND

To improve situational awareness, electronic accessory devices such as lights, radios, thermal imaging cameras, range finders, displays, and the like are added to firearms. Each electronic accessory device typically has its own batteries as a power source. The batteries in each electronic accessory device can add a significant amount of weight and bulk to a firearm which can make the firearm difficult to carry and aim.

Another problem is to reliably provide electrical power to the electronic accessory devices while mounted on the firearm in an environmentally hostile environment. Rain, humidity, dirt, corrosion, and extreme temperatures can interfere with the steady supply of electrical power to the electronic accessory devices when mounted on a firearm.

### SUMMARY

In general terms, the present disclosure relates to a firearm equipped with a power source for supplying electrical power to one or more firearm accessories. In one possible configuration and by non-limiting example, the firearm includes a power switch assembly that mounts onto a firearm accessory mounting location. Various aspects are described in this disclosure, which include, but are not limited to, the following aspects.

In one aspect, a firearm comprises: a lower receiver housing a power source; an upper receiver attached to the lower receiver, the upper receiver having at least one conductive strip configured to provide an electrical connection for a firearm accessory; a connector that includes electrical wiring connected to the power source in the lower receiver, the connector having a plug portion that terminates the electrical wiring; and a power switch assembly having a receptacle portion that receives the plug portion, and a fastener assembly being configurable for mounting the power switch assembly to a slot on the upper receiver, the slot providing a firearm accessory mounting location, the power switch assembly being operable to connect and disconnect the transfer of electrical power from the connector to the at least one conductive strip.

In another aspect, a kit for retrofitting a firearm comprises: a connector having a plug portion configured to terminate electrical wiring connected to a power source housed in a lower receiver of the firearm, the plug portion having a notch; a power switch assembly having a receptacle portion that receives the plug portion of the connector, and a switch configured to connect and disconnect the transfer of the electrical power from the connector to at least one conductive strip on an upper receiver of the firearm; and a safety latch having a distal end that engages the notch of the plug portion to prevent the plug portion from unplugging from the receptacle portion.

In another aspect, a power switch assembly for a firearm comprises: a receptacle portion configured to receive a plug portion of a connector that terminates electrical wiring connected to a power source housed in a lower receiver of the firearm; a switch configured to connect and disconnect the transfer of electrical power and data from the power source to a conductive strip mounted to an upper receiver of the firearm; and a safety latch having a distal end configured to engage a notch on the plug portion to prevent the plug portion from unplugging from the receptacle portion.

### DESCRIPTION OF THE FIGURES

The following drawing figures, which form a part of this application, are illustrative of the described technology and are not meant to limit the scope of the disclosure in any manner.

FIG. 1 is a front isometric view of a firearm with an integrated power source.

FIG. 2 is a rear isometric view of the firearm.

FIG. 3 is an exploded isometric view of the firearm.

FIG. 4 is an isometric view of an electrical system of the firearm.

FIG. 5 is an isometric view of a connector and a power switch assembly mounted onto an upper receiver of the firearm.

FIG. 6 is another isometric view of the connector and the power switch assembly mounted onto the upper receiver of the firearm.

FIG. 7 is an isometric view of a lower receiver of the firearm, and the connector and the power switch assembly separated from the upper receiver of the firearm.

FIG. 8 is another isometric view of the lower receiver of the firearm, and the connector and the power switch assembly separated from the upper receiver of the firearm.

FIG. 9 is an exploded isometric view of the connector and the power switch assembly relative to a handguard of the upper receive of the firearm.

FIG. 10 is another exploded isometric view of the connector and the power switch assembly positioned next the handguard of the upper receive of the firearm.

FIG. 11 is a cross-sectional view of the upper receiver of the firearm, and of the power switch assembly mounted thereon.

FIG. 12 is an exploded view of the connector and the power switch assembly.

FIG. 13 is a side view of a fastener assembly that mounts the power switch assembly to the upper receiver of the firearm.

FIG. 14 is another side view of the fastener assembly that mounts the power switch assembly to the upper receiver of the firearm.

FIG. 15 is a front view of the connector and the power switch assembly showing a safety latch that can be actuated to disengage a plug portion of the connector from a receptacle portion of the power switch assembly.

FIG. 16 is another front view of the connector and the power switch assembly showing the safety latch positioned to prevent the plug portion of the connector from disconnecting from the receptacle portion of the power switch assembly.

FIG. 17 is a top view of the safety latch.

### DETAILED DESCRIPTION

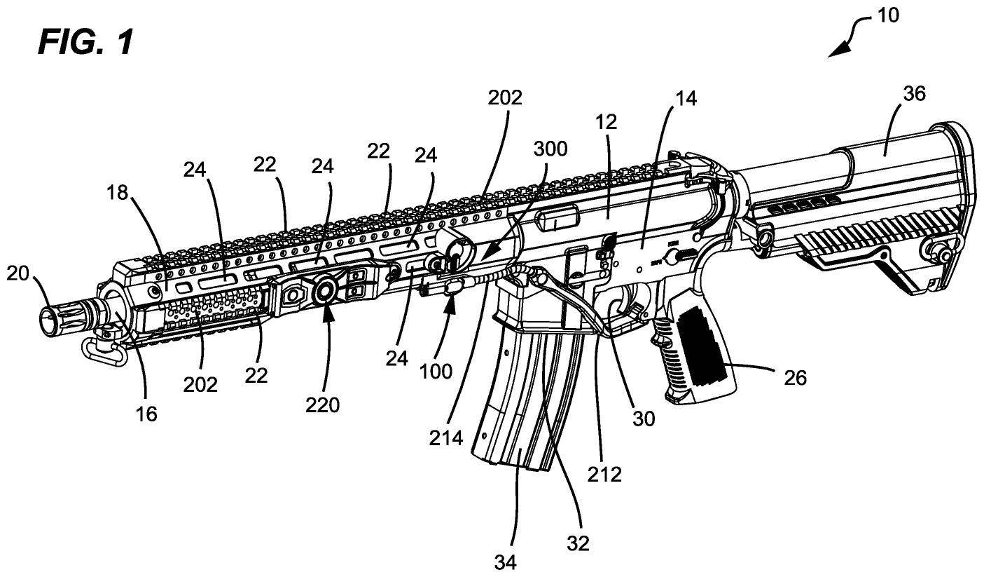

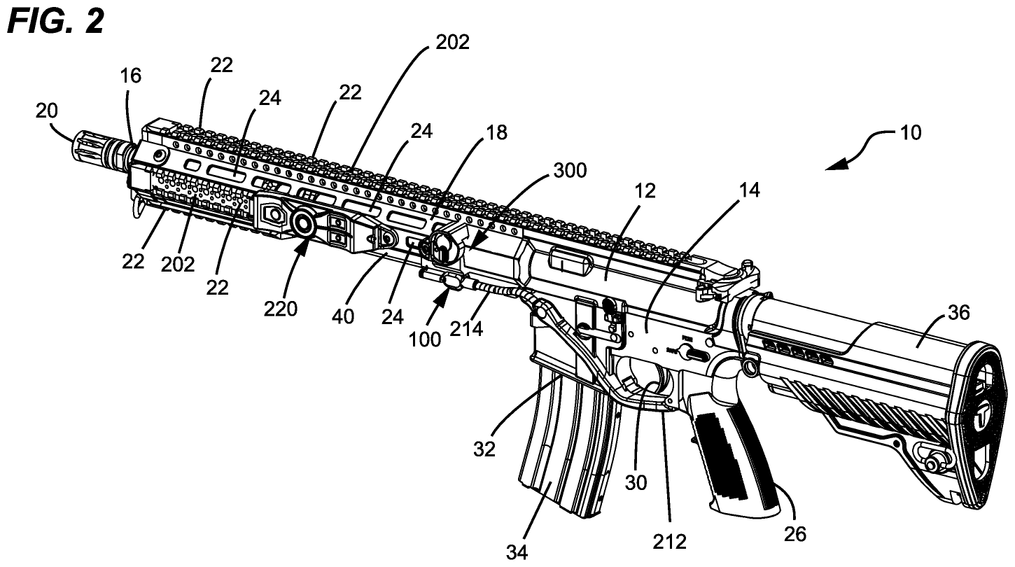

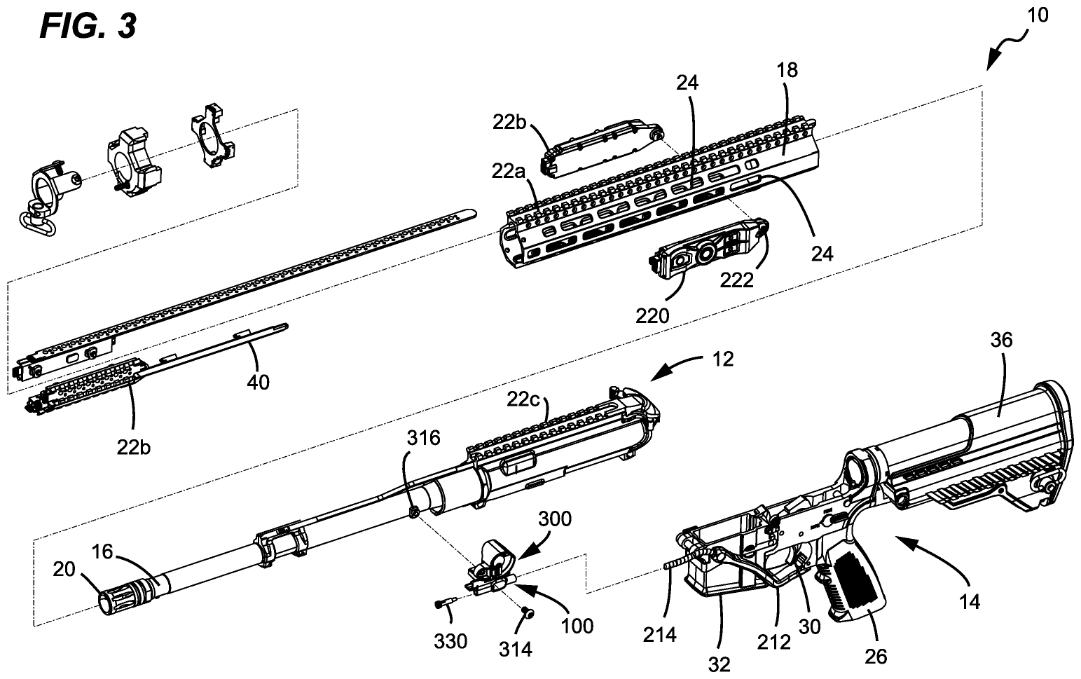

FIGS. 1 and 2 are front and rear isometric views, respectively, of a firearm 10. FIG. 3 is an exploded isometric view of the firearm 10. The firearm 10 operates to fire a round of ammunition. While a military-style firearm is shown in these figures, the various embodiments, concepts, and features that are described herein can be incorporated into other types of firearms including handguns, bolt action rifles, shotguns, fixed-mount machine guns, as well as into other types of weapons such as bows and non-weapons such as air-soft (e.g., paint ball) systems.

The firearm 10 includes an upper receiver 12 that attaches to a lower receiver 14. The upper receiver 12 includes a barrel 16, a handguard 18 that partially surrounds the barrel 16, and a muzzle 20 that attaches to a distal end of the barrel 16. Alternative configurations are possible in which the upper receiver 12 may include additional components not shown in the figures, or may not include all components shown in the figures such that some components are optional.

The handguard 18 includes a plurality of rails 22 that provide mounting locations for firearm accessories. The rails 22 are equally spaced apart and can be included on the top, bottom, and sides of the handguard 18 such that the firearm accessories can be mounted to the top, bottom, and sides of the handguard 18. In at least some examples, the rails 22 are Picatinny rails.

In some examples, at least some of the rails 22 are integrated with the handguard 18 such that the rails 22 and the handguard 18 are formed from a single piece of material that is molded and/or machined to have rails integrated thereon. In the example illustrated in FIG. 3, the rails 22a on the top portion of handguard 18 are integral with the handguard.

In some examples, at least some of the rails 22 are separate, modular components that attach to the handguard 18 using one or more types of fasteners. For example, FIG. 3 shows rails 22b as modular components that are added to the handguard 18 using one or more fasteners.

Additionally, in at least some examples, the rails 22 can also be provided directly on the upper receiver 12 for mounting the firearm accessories directly to the upper receiver 12. In the example illustrated in FIG. 3, the rails 22c are formed or mounted directly on a top portion of the upper receiver 12 such that they are not part of the handguard 18 or attached thereto.

The handguard 18 further includes slots 24 that provide additional mounting locations for firearm accessories on the handguard 18. The slots 24 are hollow apertures that provide negative space mounting points. In at least some examples, the slots 24 are M-LOK interfaces.

The lower receiver 14 includes a grip 26, a trigger 30, a magazine well 32 configured to hold a magazine of ammunition 34, and a buttstock 36. Alternative configurations are possible in which the lower receiver 14 may include additional components not shown in the figures, or may not include all components shown in the figures such that some components are optional.

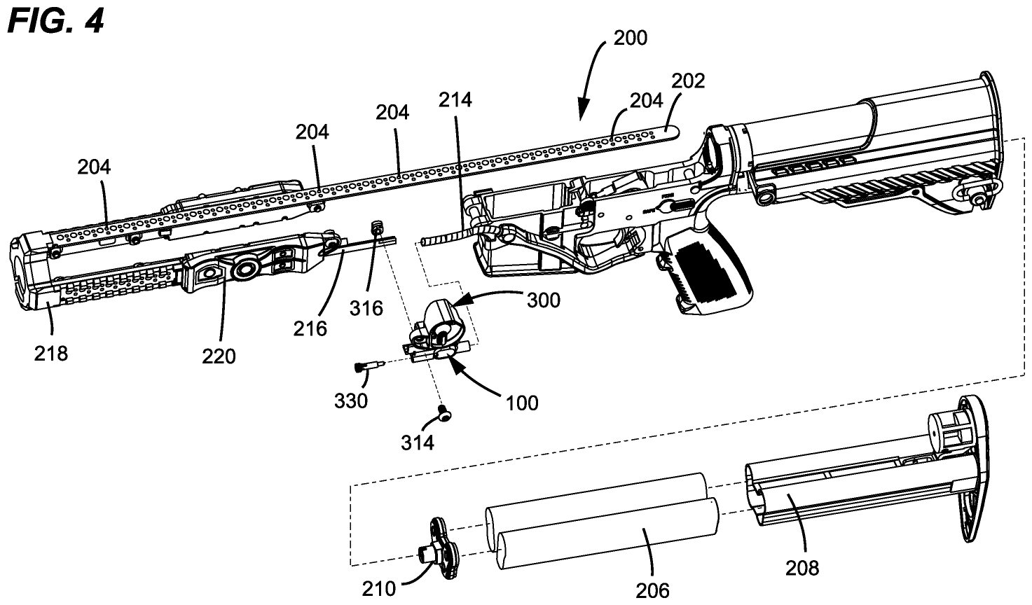

FIG. 4 shows an electrical system 200 of the firearm 10. The electrical system 200 includes at least one conductive strip 202 and a power source 206. The electrical system 200 is similar to the one shown and described in U.S. patent application Ser. No. 16/746,749, filed on Jan. 17, 2020, the entirety of which is hereby incorporated by reference.

The power source 206 provides a DC voltage that is configured for powering firearm accessories when mounted to the rails 22 of the firearm 10. In a preferred embodiment, the power source 206 includes one or more rechargeable batteries. The power source 206 is stored inside a housing 208 held inside the buttstock 36 of the firearm 10.

A socket 210 draws electrical power from the power source 206 housed in the buttstock 36. Electrical wiring carries the electrical power from the socket 210 through a trigger guard 212 and a shroud 214 mounted to the lower receiver 14, and thereafter to a connector 100. The trigger guard 212 and the shroud 214 protect the electrical wiring from outside elements. The trigger guard 212 and the shroud 214 are components that can be retrofitted onto the firearm 10. For example, the trigger guard 212 can be used to replace a stock trigger guard.

The electrical wiring includes at least a pair of electrical wires that carry the +/−DC voltage generated from the power source 206. The electrical wiring can further include additional wiring for transferring data from the power source 206 to the upper receiver 12. Thus, in at least some examples, the electrical wiring has a three conductor design with two conductors dedicated to electrical power transfer, and a third conductor dedicated to data transfer.

The data transfer enables the power source 206 to be networked with additional devices mounted on and off of the firearm 10. For example, a firearm accessory mounted on the upper receiver 12, such as an optical sight, can receive the data from the power source 206 for displaying a charge level of the power source 206 while being used by a user of the firearm 10. In such example, the user of the firearm 10 can be alerted that the charge level of the power source 206 is running low such that they will need to re-charge or replace the power source 206.

As another example, a firearm accessory, such as a communications router, can be used to communicate the data from the power source 206 off of the firearm 10 to one or more remote devices such as through encrypted radio, cellular, or satellite communications. As an illustrative example, a central command server can receive the data from the power source 206 to alert central command about the charge level of the power source 206. Thereafter, central command can use the data to make informed decisions such as whether to continue battle operations based on the charge level of the power source 206 on the firearm 10.

The connector 100 transfers the electrical power from the power source 206 in the lower receiver 14, to electrical wiring 216 that runs along the upper receiver 12. A power switch assembly 300 can be actuated by a user of the firearm 10 to connect and disconnect the transfer of electrical power and data from the lower receiver 14 to the upper receiver 12. The connector 100 and power switch assembly 300 will be described in more detail below.

The electrical wiring 216 in the upper receiver 12 is housed inside a sheath 40 mounted to the handguard 18. The electrical wiring 216 and the sheath 40 run along a length of the upper receiver 12 and substantially parallel to the barrel 16 and handguard 18. The sheath 40 protects the electrical wiring 216 from outside elements, and prevents the electrical wiring 216 from being snagged by outside elements such as branches, wires, cables, and the like.

The electrical wiring 216 includes a pair of electrical wires that carry the +/−DC voltage generated from the power source 206, and additional wiring for transferring data from the power source 206. The electrical wiring 216 transfers the electrical power and data to a conductive bus assembly 218 mounted at a distal end of the upper receiver 12.

The conductive bus assembly 218 distributes the electrical power and data to the at least one conductive strip 202 mounted on the handguard 18. In examples where a plurality of conductive strips 202 are mounted around the barrel 16 of the firearm 10, the conductive bus assembly 218 distributes the electrical power and data to the plurality of conductive strips 202. The conductive bus assembly 218 can also distribute the electrical power and data to one or more conductive strips that are mounted directly to the upper receiver 12 such as between the rails 22c.

As shown in FIGS. 1-4, at least one conductive strip 202 is held on the rails 22. Each conductive strip 202 includes a plurality of electrical contacts 204. A firearm accessory can mechanically engage the rails 22 for fixation onto the firearm 10, and can electrically connect to the electrical contacts 204 of a conductive strip 202 held between the rails 22 to receive electrical power from the power source 206 housed in the lower receiver 14 of the firearm 10.

A plurality of conductive strips 202 can be mounted on the top, bottom, and sides of the handguard 18 such that electrical power from the power source 206 can be supplied to a plurality of firearm accessories mounted on the top, bottom, and sides of the handguard 18. Additionally, in at least some examples, a conductive strip 202 can be held between the rails 22c provided directly on the upper receiver 12 for supplying electrical power to one or more firearm accessories that are mounted directly to the upper receiver 12.

A control module 220 is connected to a rail 22b attached to the handguard 18. The control module 220 includes one or more buttons that can receive manual inputs from a user of the firearm 10 to control the operation of one or more firearm accessories mounted to at least one conductive strip 202 on the firearm 10. The control module 220 can communicate with the one or more firearm accessories over the conductive strips 202 using, for example, impressed communications over DC power. The control module 220 enables a user of the firearm 10 to control multiple firearm accessories from a single, convenient location on the firearm 10.

In the examples illustrated in the figures, the control module 220 is attached to a left side of the handguard 18. Alternatively, the control module 220 can be attached to a right side of the handguard 18. Thus, the control module 220 can be attached to either side of the handguard.

In the examples illustrated in the figures, the control module 220 is at least partially secured to the handguard 18 by a fastener 222 such as a screw and bolt assembly that clamps the control module 220 onto the handguard 18. Alternatively, the control module 220 can include a grip mechanism that engages the rails 22 to secure the control module 220 to the firearm 10.

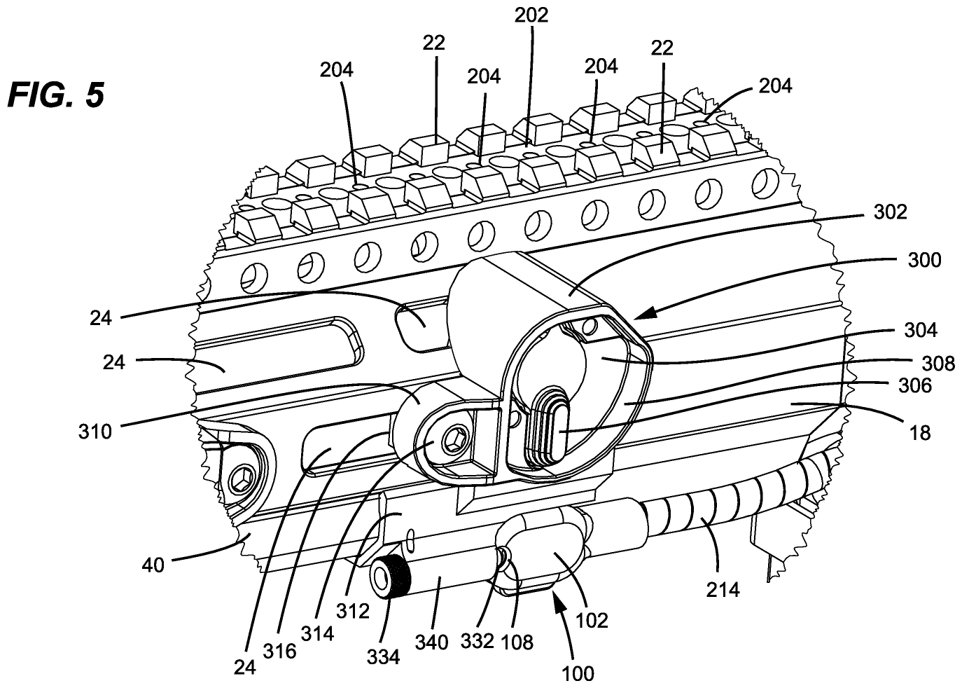

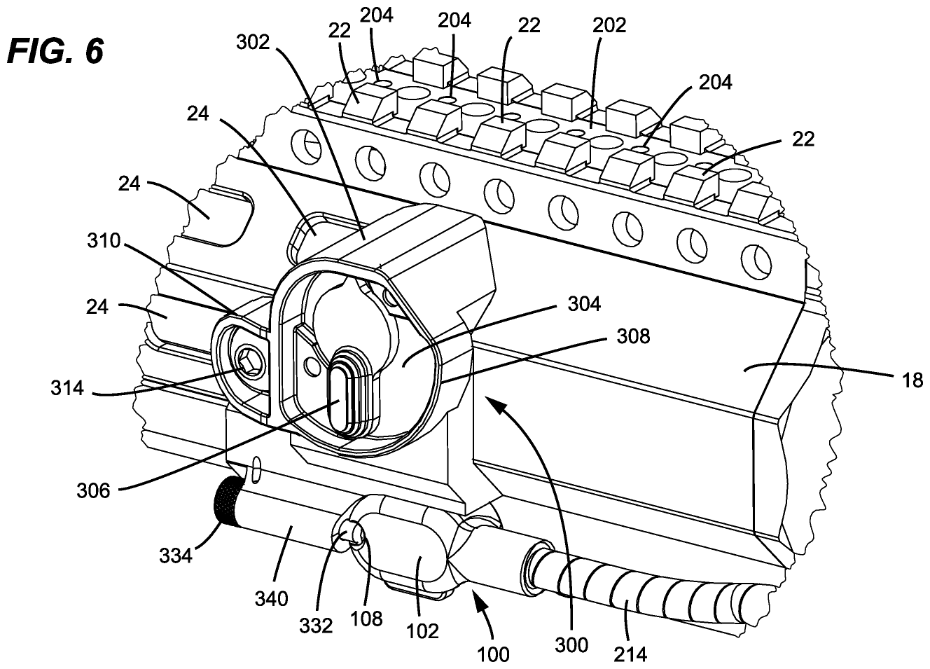

FIGS. 5 and 6 are isometric views of the connector 100 and the power switch assembly 300 mounted on the upper receiver 12. In the example shown in FIGS. 5 and 6, the power switch assembly 300 is mounted to the handguard 18 where a slot 24 is located.

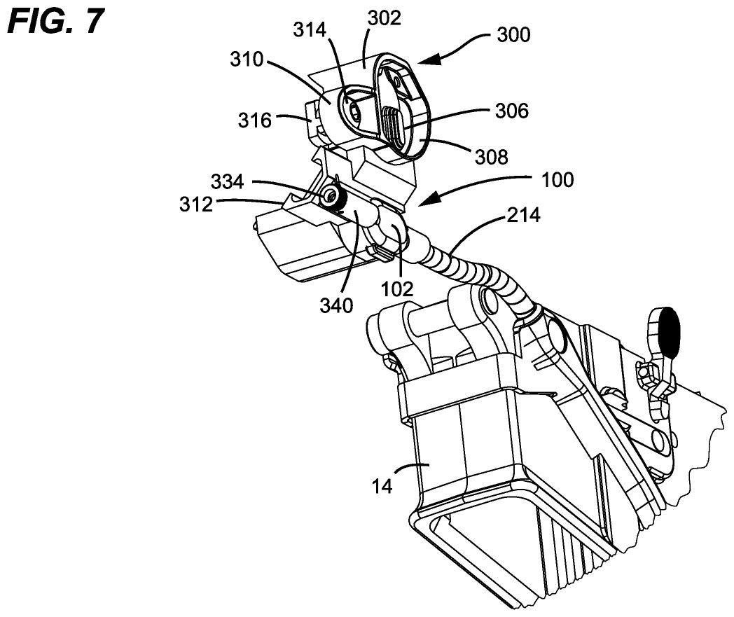

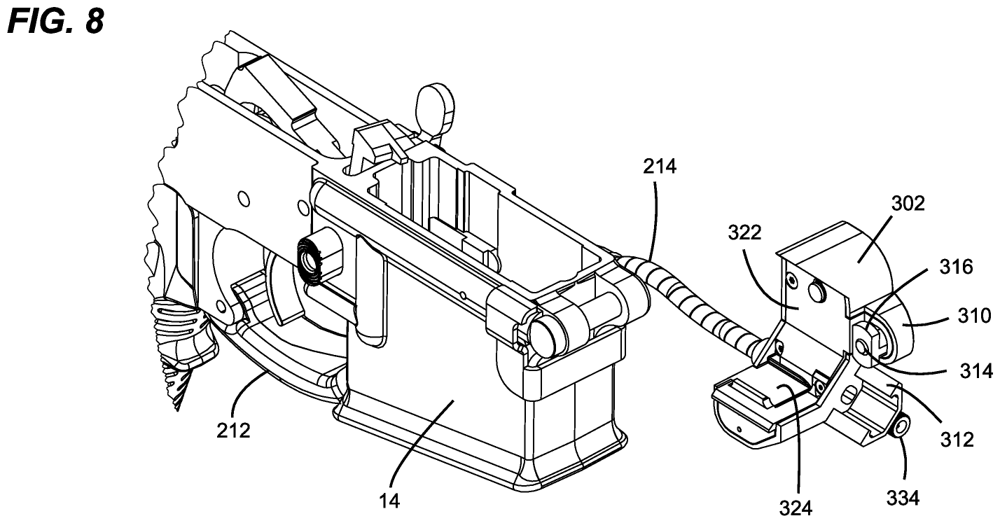

FIGS. 7 and 8 are isometric views of the connector 100 and power switch assembly 300 separate from the upper receiver 12. Referring now to FIGS. 5-8, the connector 100 transfers the electrical power and data from the power source 206 housed in the lower receiver 14 to the power switch assembly 300. The power switch assembly 300 is operable by a user to connect and disconnect the supply of the electrical power and data to the upper receiver 12.

The power switch assembly 300 includes a housing 302 that is structured for mounting onto the upper receiver 12 of the firearm. The shape of the housing 302 is configured to conform to the shape of the handguard 18 of the firearm. For example, FIG. 8 shows the housing 302 as having an interior side surface 322 that abuts an exterior side surface of the handguard 18, and the housing 302 further includes an interior bottom surface 324 that abuts an exterior bottom surface of the handguard 18 when the housing 302 is mounted onto the handguard 18 of the firearm. The shape and dimensions of the housing 302, including that of the interior side surface 322 and the interior bottom surface 324, may vary based on the shape and dimensions of the upper receiver 12 and the handguard 18 of the firearm.

In the examples illustrated in the figures, the power switch assembly 300 and connector 100 are attached to the left side of the handguard 18. Alternatively, the power switch assembly 300 and connector 100 can be attached to the right side of the handguard 18. Thus, the power switch assembly 300 and connector 100 can be attached to either side of the handguard.

The housing 302 has an exterior area 304 where a switch 306 is mounted. The switch 306 is configured for actuation by a user to connect and disconnect the supply of electrical power and data to the upper receiver 12. In the examples illustrated in the figures, the exterior area 304 is at least partially surrounded by an exterior wall 308 such that the exterior area 304 and the switch 306 are recessed in the housing 302. Advantageously, the exterior wall 308 can prevent accidental actuation of the switch 306 while the firearm 10 is being used.

The switch 306 is actuated by a user of the firearm 10 by pivoting from a horizontal position to a vertical position, and by pivoting from the vertical position to the horizontal position. As an illustrative example, the switch 306 when in the vertical position (as shown in FIGS. 5 and 6) allows the supply of electrical power and data to the upper receiver 12 (i.e., the conductive strips 202 are powered on), and when in the horizontal position, the switch 306 blocks the supply of electrical power and data to the upper receiver 12 (i.e., the conductive strips 202 are powered off). In the examples illustrated in the figures, the switch 306 resembles the safety of a military-style firearm. Alternative designs for the switch 306 are possible.

Alternative arrangements for actuating a switch to connect and disconnect the supply of electrical power and data from the lower receiver 14 to the upper receiver 12 are possible such that the pivoting actuation described herein is provided by way of illustrative example. For example, in alternative arrangements, the switch 306 can be a pin that is configured to slide left and right, or up and down, to connect and disconnect the transfer of the electrical power and data to the upper receiver 12. In further alternative arrangements, the switch 306 can be a button that can be depressed to connect and disconnect the transfer of the electrical power and data to the upper receiver 12. Further alternative arrangements are contemplated.

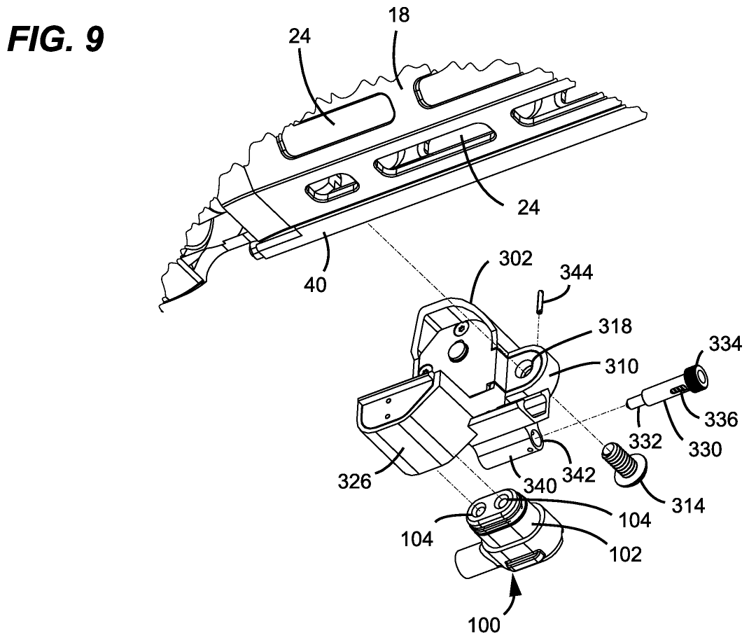

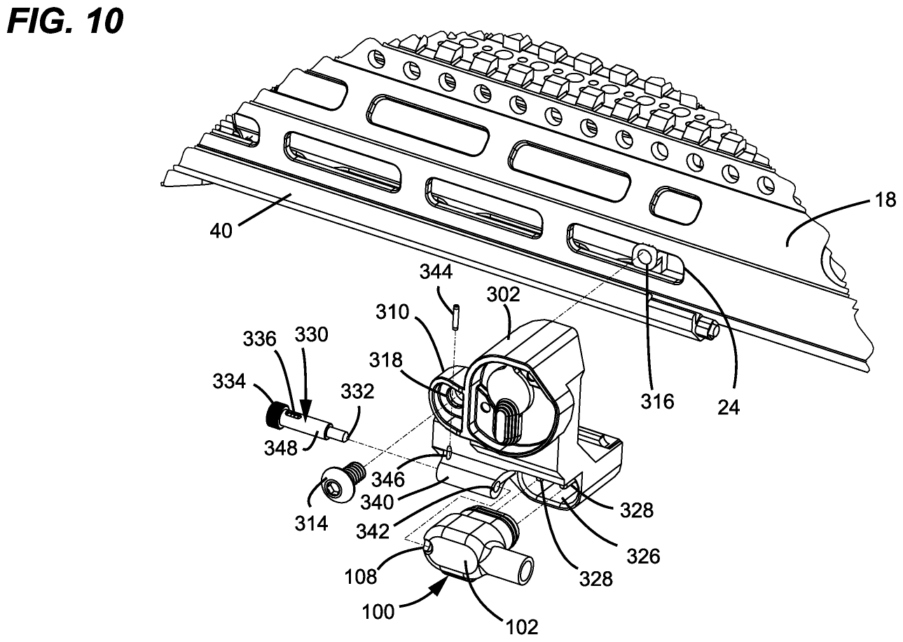

FIGS. 9 and 10 are exploded isometric views of the connector 100 and the power switch assembly 300 relative to the handguard 18. Referring now to FIGS. 5-10, the housing 302 can further include a lateral portion 310 that receives a fastener assembly for attaching the power switch assembly 300 to the handguard 18 of the firearm 10. The fastener assembly can be used to retrofit a firearm with the power switch assembly 300.

The fastener assembly includes a screw 314 and a bolt 316. The screw 314 is configured for insertion through an aperture 318 in the lateral portion 310 of the housing 302, and through a slot 24 of the handguard 18 to engage the bolt 316. The screw 314 has exterior threads that are configured to threadedly engage interior threads of the bolt 316.

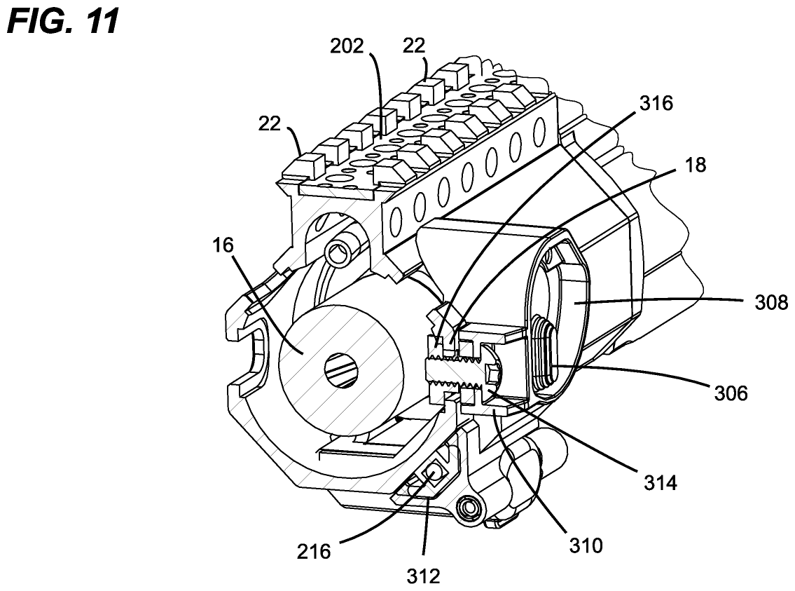

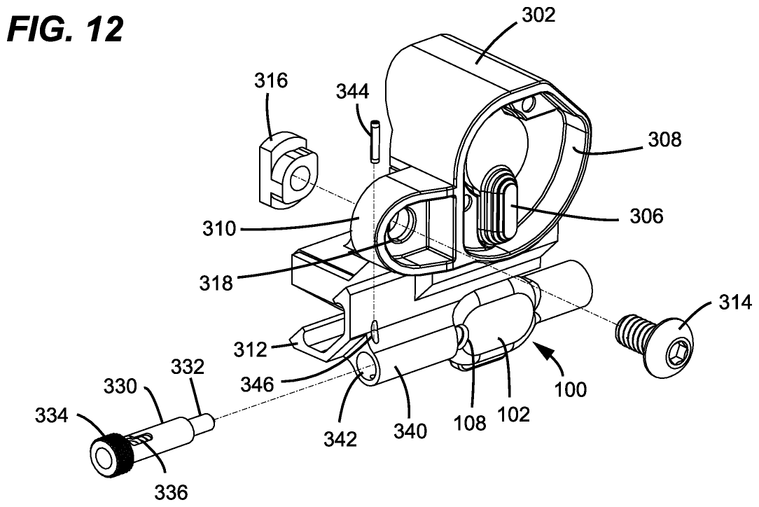

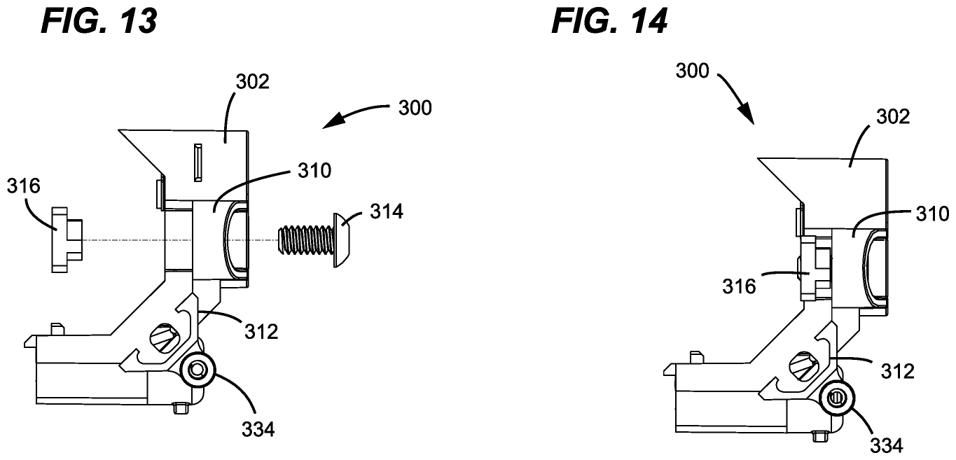

FIG. 11 is a cross-sectional view of the handguard 18 and the power switch assembly 300. FIG. 12 is an exploded view of the power switch assembly 300. FIGS. 13 and 14 are side views of the fastener assembly that is used to fix the power switch assembly 300 to the handguard 18 of the firearm. Referring now to FIGS. 11-14, when a rotational force is applied to the screw 314, such as by using a wrench or screwdriver, the screw 314 rotates such that the threaded engagement between the screw 314 and the bolt 316 causes the screw 314 and the bolt 316 to clamp the lateral portion 310 of the housing 320 onto the handguard 18, and thereby attach the power switch assembly 300 to the handguard 18. Thus, as the screw 314 and bolt 316 tighten due to the rotation of the screw, an area of the handguard 18 adjacent to the slot 24 is clamped between bolt 316 and the housing 302 of the power switch assembly 300. In certain examples, the slots 24 are M-LOK interfaces such that the fastener assembly can be used to retrofit a stock firearm having M-LOK interfaces with the power switch assembly 300.

In the examples illustrated in the figures, the screw 314 has a hexagonal socket that is configured for engagement by a hex key, also known as an Allen key or Allen wrench, that can be used to apply the rotational force to tighten the screw 314 and bolt 316 around the slot 24 of the handguard 18. Alternative socket designs for the screw 314 are possible such that a variety of different wrenches and screwdrivers can be used to rotate and tighten the screw 314.

The screw 314 is insertable through the aperture 318 in the lateral portion 310 of the housing 302 such that the screw 314 does not interfere with the placement and actuation of the switch 306. In alternative arrangements, it is contemplated that the exterior area 304 can include an aperture for receiving the screw 314 such that the housing 302 does not include the lateral portion 310, and instead, the screw 314 is inserted through the exterior area 304 or other area of the housing 302 for attaching the power switch assembly 300 to the upper receiver 12.

Referring now to FIGS. 7, 8, and 11, the housing 302 of the power switch assembly 300 further includes an extension 312 that aligns with the sheath 40 mounted to the handguard 18. The extension 312 and sheath 40 provide a continuous and uninterrupted path for the electrical wiring 216 to run from the power switch assembly 300 to the conductive bus assembly 218, and that protects the electrical wiring 216 from outside elements such as water and dirt, and prevents the electrical wiring 216 from being snagged by branches, wires, cables, and the like.

Referring back to FIGS. 5, 6, 9, and 10, the connector 100 includes a plug portion 102 that terminates the electrical wiring housed inside the shroud 214. As shown in FIGS. 9 and 10, the plug portion 102 is received by a receptacle portion 326 of the power switch assembly 300.

The plug portion 102 includes one or more electrical contacts that engage one or more corresponding electrical contacts 328 inside the receptacle portion 326. In the example illustrated in the figures, the electrical contacts 328 are prongs that are received inside corresponding apertures 104 of the plug portion 102 for contact with the electrical contacts of the plug portion 102. In alternative arrangements, the electrical contacts of the plug portion 102 can be prongs that are received inside corresponding apertures in the receptacle portion 326.

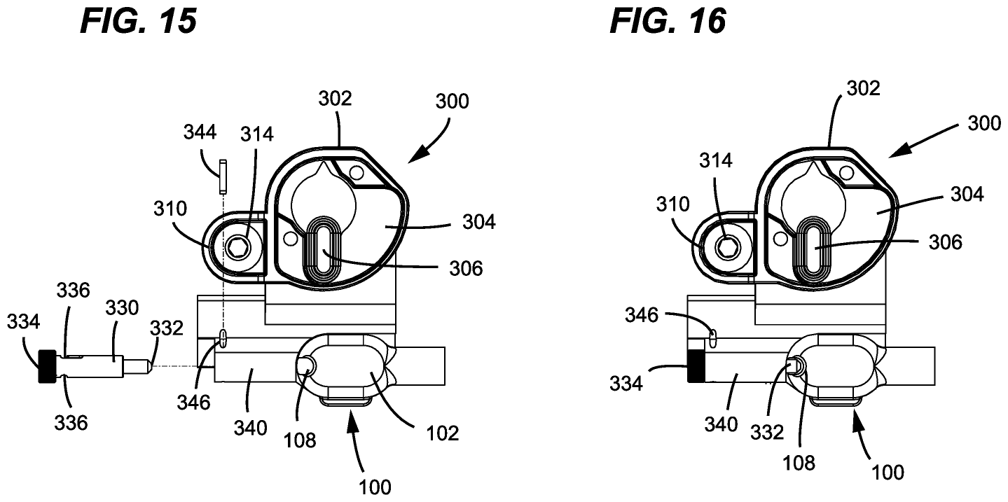

FIGS. 15 and 16 are front views of the connector 100 and the power switch assembly 300 showing a safety latch 330 that is housed inside a safety latch housing 340 of the power switch assembly 300. FIGS. 10 and 12 show that the safety latch 330 slots through an aperture 342 of the safety latch housing 340. The safety latch 330 is used to lock and unlock the plug portion 102 with respect to the receptacle portion 326 of the power switch assembly 300.

As shown in FIGS. 15 and 16, the plug portion 102 has a notch 108 that receives a distal end 332 of the safety latch 330 when the safety latch is fully inserted through the safety latch housing 340 of the power switch assembly 300. FIG. 10 shows that the distal end 332 of the of the safety latch 330 has a smaller diameter than the main body 348 of the safety latch 330. As shown in FIGS. 10 and 12, a distal end of the aperture 342 of the safety latch housing 340 has a smaller diameter than a proximal end of the aperture 342. Thus, the safety latch 330 is shaped to slot through the aperture 342 such that the distal end 332 projects beyond the distal end of the aperture 342 allowing the distal end 332 to reach the notch 108. The distal end 332 prevents the plug portion 102 from becoming unplugged from the receptacle portion 326 by blocking the plug portion 102 from detaching from the receptacle portion 326.

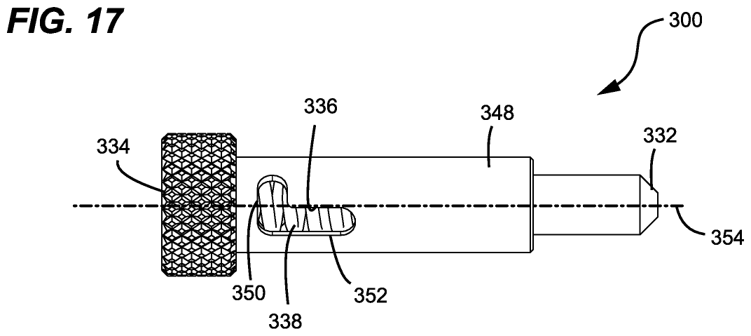

FIG. 17 is a top view of the safety latch 330. Referring now to FIGS. 15-17, the safety latch 330 includes a head 334 that can be turned to rotate the safety latch 330 while inside the safety latch housing 340. The safety latch 330 has a groove 336 on the main body 348 that receives a pin 344 inserted through an aperture 346 of the safety latch housing 340. As shown in FIG. 17, the main body 348 has a hollow interior that houses an internal spring coil 338.

The groove 336 is shaped such that when the head 334 of the safety latch 330 is rotated by the fingers of a user of the firearm 10, the safety latch 330 can be pulled by the user in a direction away from the notch 108 of the plug portion 102. For example, the groove 336 is L shaped and includes a first portion 350 that is substantially orthogonal to a lengthwise axis 354 of the safety latch 330, and a second portion 352 that is substantially parallel to the lengthwise axis 354. When the safety latch 330 is rotated, the pin 344 becomes aligned with the second portion 352 of the groove 336 such that the safety latch 330 can be pulled along the lengthwise axis 354. The length of the second portion 352 defines a distance that the safety latch 330 can be pulled. In some further examples, the groove 336 and pin 344 provide a bayonet mount or bayonet connector for the safety latch 330 inside the safety latch housing 340.

When the safety latch 330 is pulled by the predetermined distance defined by the length of the second portion 352 of the groove 336, the distal end 332 of the safety latch 330 is moved out of the notch 108, and thereby allows the plug portion 102 to be unplugged and removed from the receptacle portion 326 of the power switch assembly 300.

The internal spring coil 338 engages the pin 344 to bias the safety latch 330 in a direction toward the plug portion 102 of the connector 100 such that the safety latch 330 returns toward the plug portion 102 when released by the hand of the user. The user can use the head 334 to rotate the safety latch 330 such that the pin 344 is contained inside the first portion 350 of the groove 336, and thereby the pin 344 prevents the safety latch 330 from being pulled in the direction away from the plug portion 102 of the connector 100. In this position, the distal end 332 is locked in position for engaging the notch 108 of the plug portion 102, and thereby the plug portion 102 is prevented from unplugging from the receptacle portion 326.

The various embodiments described above are provided by way of illustration only and should not be construed to be limiting in any way. Various modifications can be made to the embodiments described above without departing from the true spirit and scope of the disclosure.

What is claimed is:

1. A firearm comprising:
a lower receiver housing a power source;
an upper receiver attached to the lower receiver, the upper receiver having at least one conductive strip configured to provide an electrical connection for a firearm accessory;
a connector that includes electrical wiring connected to the power source in the lower receiver, the connector having a plug portion that terminates the electrical wiring; and
a power switch assembly having a receptacle portion that receives the plug portion, and a fastener assembly being configurable for mounting the power switch assembly to a slot on the upper receiver, the slot providing a firearm accessory mounting location, the power switch assembly being operable to connect and disconnect the transfer of electrical power from the connector to the at least one conductive strip.

2. The firearm of claim 1, wherein the fastener assembly clamps a housing of the power switch assembly onto a portion of the upper receiver adjacent to the slot.

3. The firearm of claim 1, wherein the slot is an M-LOK interface.

4. The firearm of claim 1, further comprising:
a safety latch that prevents the plug portion of the connector from unplugging from the receptacle portion of the power switch assembly.

5. The firearm of claim 4, wherein the safety latch includes a distal end that engages a notch on the plug portion to block the plug portion from detaching from the receptacle portion.

6. The firearm of claim 5, wherein the safety latch is configured to be rotated and pulled in a direction away from the plug portion to disengage the distal end from the notch of the plug portion, and allow the plug portion to be unplugged from the receptacle portion.

7. The firearm of claim 6, wherein the safety latch is spring biased in a direction toward the plug portion such that the distal end is biased to engage the notch of the plug portion and to prevent the plug portion from unplugging from the receptacle portion.

8. The firearm of claim 1, further comprising electrical wiring that carries both voltage and data generated from the power source to the at least one conductive strip.

9. A kit for retrofitting a firearm, comprising:
a connector having a plug portion configured to terminate electrical wiring connected to a power source housed in a lower receiver of the firearm, the plug portion having a notch;
a power switch assembly having a receptacle portion that receives the plug portion of the connector, and a switch configured to connect and disconnect the transfer of the electrical power from the connector to at least one conductive strip on an upper receiver of the firearm; and
a safety latch having a distal end that engages the notch of the plug portion to prevent the plug portion from unplugging from the receptacle portion.

10. The kit of claim 9, wherein the safety latch is configured to be rotated and pulled in a direction away from the plug portion to disengage the distal end from the notch, allowing the plug portion to be unplugged and removed from the receptacle portion.

11. The kit of claim 9, wherein the safety latch is spring biased in a direction toward the plug portion such that the distal end is biased to engage the notch of the plug portion and prevent the plug portion from unplugging from the receptacle portion.

12. The kit of claim 9, wherein the connector is configured to transfer both voltage and data generated from the power source to the power switch assembly.

13. The kit of claim 9, further comprising:
a fastener assembly configurable for mounting the power switch assembly to a slot on the upper receiver of the firearm, the slot providing a firearm accessory mounting location.

14. The kit of claim 13, wherein the fastener assembly clamps a housing of the power switch assembly onto a portion of the upper receiver adjacent to the slot.

15. The kit of claim 13, wherein the slot is an M-LOK interface.

16. A power switch assembly for a firearm, comprising:
a receptacle portion configured to receive a plug portion of a connector that terminates electrical wiring connected to a power source housed in a lower receiver of the firearm;
a switch configured to connect and disconnect the transfer of electrical power and data from the power source to a conductive strip mounted to an upper receiver of the firearm; and
a safety latch having a distal end configured to engage a notch on the plug portion to prevent the plug portion from unplugging from the receptacle portion.

17. The power switch assembly of claim 16, wherein the safety latch is configured to be rotated and pulled in a direction away from the plug portion to disengage the distal end from the notch, allowing the plug portion to be unplugged and removed from the receptacle portion.

18. The power switch assembly of claim 16, further comprising:
a fastener assembly for mounting the power switch assembly to a slot on the upper receiver, the slot providing a firearm accessory mounting location.

19. The power switch assembly of claim 18, wherein the fastener assembly clamps a housing of the power switch assembly onto a portion of the upper receiver adjacent to the slot.

20. The power switch assembly of claim 18, wherein the slot is an M-LOK interface.
